(19) United States
(12) Patent Application Publication
(10) Pub. No.: US 2019/0357691 A1
(43) Pub. Date: Nov. 28, 2019

(54) DECORATIVE LEG COVER FOR A BED FRAME

(71) Applicant: Sandra Rizzo, Kenosha, WI (US)

(72) Inventor: Sandra Rizzo, Kenosha, WI (US)

(21) Appl. No.: 16/127,636

(22) Filed: Sep. 11, 2018

Related U.S. Application Data
(60) Provisional application No. 62/559,527, filed on Sep. 16, 2017.

(51) Int. Cl. A47C 19/22; A47C 19/02; F21V 33/00; F21V 23/04

(52) U.S. Cl. CPC A47C 19/22; A47C 19/024; F21W 2131/301; F21V 23/0471; F21V 33/0012

(57) ABSTRACT

A decorative leg cover, the leg cover comprising: a light and a receptacle for receiving a bed leg. The light includes a light housing and an LED on the front side of the light housing. The light also includes a proximity sensor on the front side. The receptacle has a receptacle opening therein adapted to receive the bed leg, the light being mounted on the receptacle so that the LED shines away from the receptacle.

### FIELD OF THE INVENTION

The present disclosure relates to a decorate leg cover for a bed frame including a rectangular frame, with at least two perpendicularly extending legs, each leg connected to and extending from about a corner of the rectangular frame.

### BACKGROUND OF THE INVENTION

Most beds have a mattress supported on a metal bed frame. The frame is a rectangular frame, with four perpendicularly extending legs, each leg extending from about a corner of the rectangular frame. Each leg is usually mounted on a wheel for allowing the bed frame to be rolled around.

With such beds, the metal bed frame is often visible, and the frame legs are easily accessible from aside the bed. As a result, it is not uncommon for a person to stub a toe against the frame leg or wheel. Further, since most people often sleep in the dark, there is little light around a bed to aid a person in seeing where the bed frame leg is located.

What is needed is a way to cover the unsightly metal bed frame, and to help prevent someone from stubbing a toe.

### SUMMARY OF THE INVENTION

Disclosed is a decorative leg cover the leg cover comprising: a light and a receptacle for receiving a bed leg. The light includes a light housing and an LED on the front side of the light housing. The light also includes a proximity sensor on the front side. The receptacle has a receptacle opening therein adapted to receive the leg, the light being mounted on the receptacle so that the LED shines away from the receptacle.

### BRIEF DESCRIPTION OF THE DRAWINGS

FIG. 1 is a top pair of two pairs of leg covers, each pair having a side rail cover extending between the leg covers.

FIG. 2 is a top view of two pairs of leg covers, each pair having a side rail cover extending between the leg covers, with a metal bed frame received between and in the pair of leg covers.

FIG. 3 is a side perspective view of a metal bed frame, with one bed leg received in a leg cover according to this disclosure.

FIG. 4 is a side perspective view of a medal bed frame, with each of four bed legs received in a respective leg cover.

FIG. 5 is a side perspective view of a metal bed frame, with two pairs of leg covers, each pair having a side rail cover extending between the leg covers, with a metal bed frame received in and between the pair of leg covers, the side rail cover obscuring the bed frame.

FIG. 6 is a side perspective view of a bed cover with a light mounted in a receptacle opening, the light being mounted in the receptacle so that the LED shines away from the receptacle.

FIG. 7 is an exploded side perspective view of the leg cover of FIG. 6.

FIG. 8 is a side view of a bed frame being dropped down into a pair of spaced apart leg covers connected by a side rail cover.

FIG. 9 is a front perspective view of a light according to this disclosure.

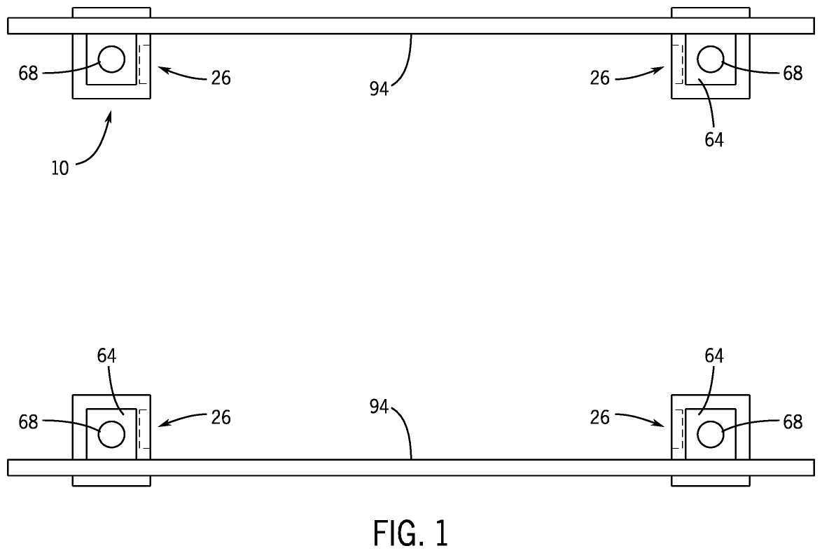

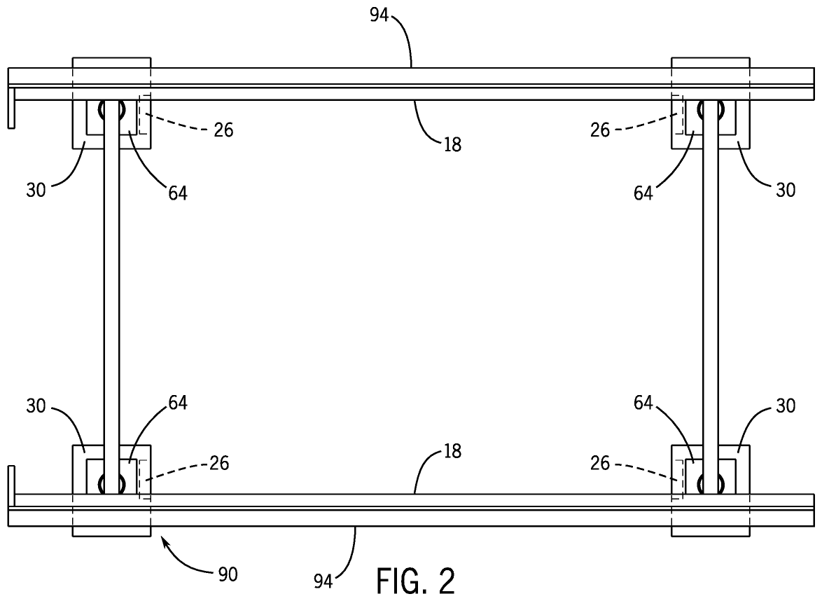

Before one embodiment of the disclosure is explained in detail, it is to be understood that the disclosure is not limited in its application to the details of the construction and the arrangements of components set forth in the following description or illustrated in the drawings. The disclosure is capable of other embodiments and of being practiced or being carried out in various ways. Also, it is to be understood that the phraseology and terminology used herein is for the purpose of description and should not be regarded as limiting. Use of “including” and “comprising” and variations thereof as used herein is meant to encompass the items listed thereafter and equivalents thereof as well as additional items. Use of “consisting of” and variations thereof as used herein is meant to encompass only the items listed thereafter and equivalents thereof. Further, it is to be understood that such terms as “forward”, “rearward”, “left”, “right”, “upward”, “downward”, “side”, “top”, and “bottom”, etc., are words of convenience and are not to be construed as limiting terms.

### DESCRIPTION OF THE EMBODIMENT

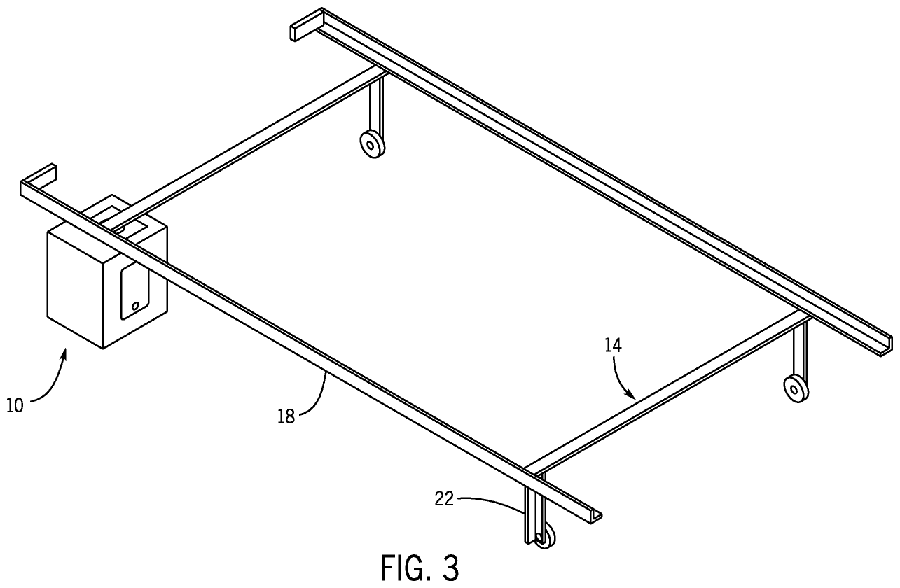

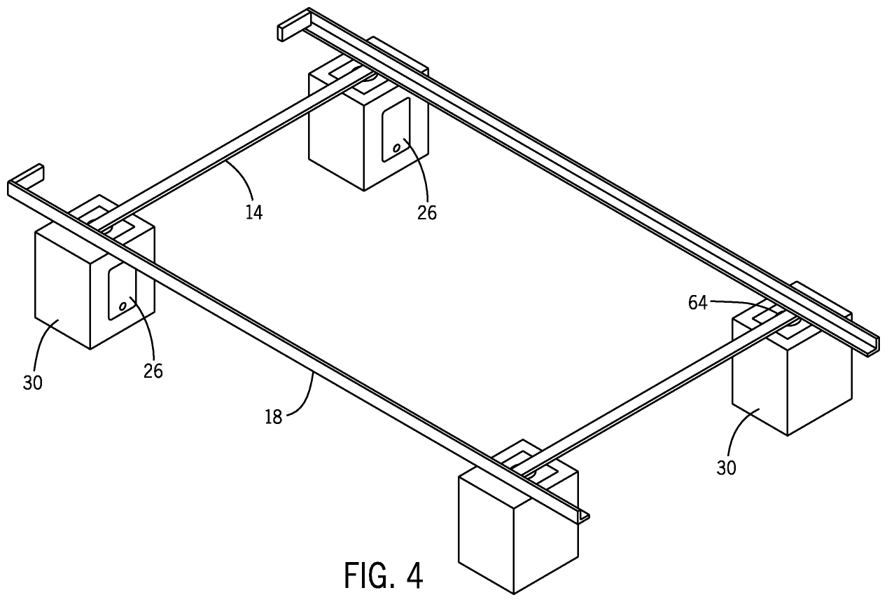

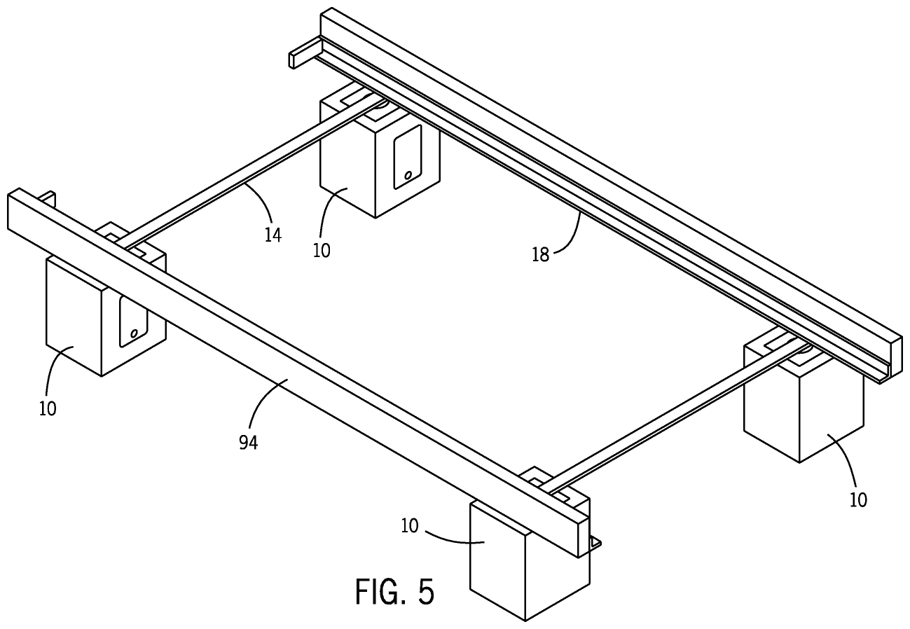

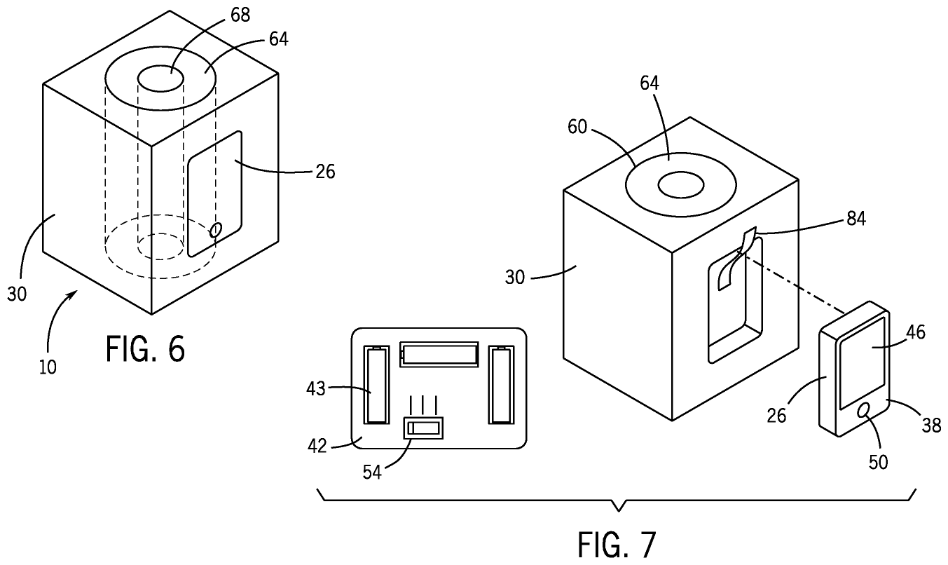

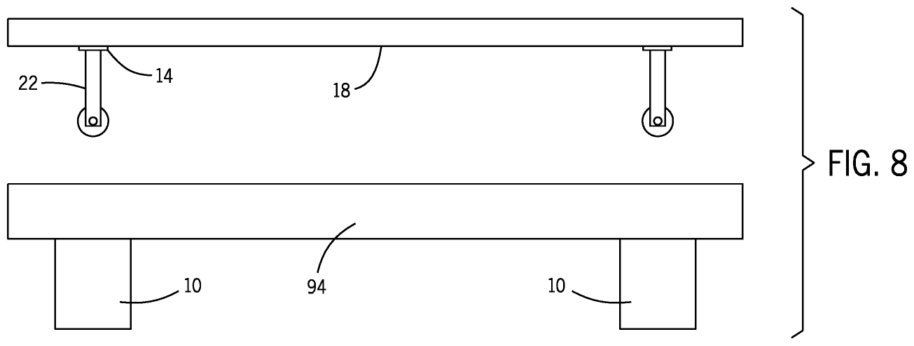

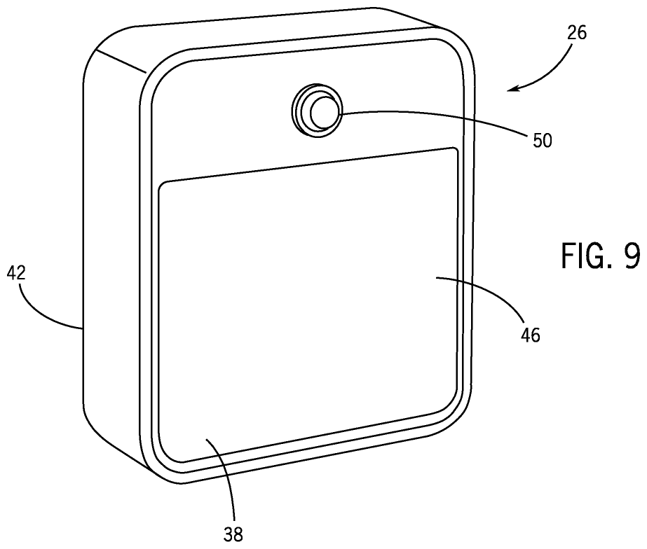

Disclosed in the drawings is a decorative leg cover 10 for a bed frame 14 (see FIG. 3) including rectangular frame 18, with four perpendicularly extending bed legs 22, each leg extending from about a corner of the rectangular frame 18, as shown in FIG. 3.

The leg cover 10 according to this disclosure comprises a light 26 (see FIG. 7), and a receptacle 30 for receiving the bed leg 22. The light 26 includes a light housing 34 having a front side 38 and a back side 42, and an LED 26 on the front side 38 of the light housing 34. The light 26 further includes a proximity sensor 50 on the front side 38, operable to turn the LED 46 on when it senses movement near the light 26, and then turn off the light 26 a short time duration thereafter. The light 26 also includes an off switch 54 on the back side 42 of the light housing 34, operable to turn the LED 46 on and off. Batteries 43 for the light 26 can be accessed and replaced from the back side 42 of the light 26. Such a light 26 is commercially available, for example, as Mr. Beams (trademark) MB722 Battery Powered Motion Sensing LED Stick Anywhere Night Light, White. The light 26 is relatively thin in thickness between the front and back sides.

The receptacle 30 is in the form of a four sided block made of at least semi-rigid material, such as wood or rubber, and has a receptacle opening 60 therein adapted to receive a respective bed leg 22. The receptacle opening 60 is deep enough to hold most of the bed leg 22 and is sized to snugly receive the bed leg 22. In one embodiment, a foam material 64 is received in the receptacle opening 60, the foam material 64 having a leg opening 68 therein adapted to receive the bed leg 22. The foam material can flow and conform to a variety of leg width dimensions, and helps to hold the leg 22 in the receptacle 30.

The light 26 is mounted on the receptacle 30 in a receptacle recess 70 in the exterior of the receptacle 30, the recess 70 receiving the light 26 therein so that the LED 46 shines away from the receptacle 30. When received in the recess 70, the light front side 38 is flush with the side of the receptacle 30 around the receptacle recess 70. A ribbon 84 has one end secured to one side of the recess 70, and another end free and extending across the recess 70 behind the light 26, with the free end outside the recess 70. The ribbon 84 aids in the removal of the light 26 from the recess 70 when needed to replace batteries, for example.

In one embodiment, a leg cover assembly 90 further includes a rail cover 94 attached to and extending between two of the leg covers 10. The two leg covers 10 are spaced apart so that each leg cover 10 can receive a different one of the four legs, and the rail cover has a height extending parallel to the legs sufficient to cover a height of a bed frame side.

The rail cover 94 is attached to a side of each of the leg covers, with the LED of each leg cover shining toward the LED of the other cover.

In addition to the leg covers, or leg covers and rail covers being added to an existing bed frame, a bed frame could also, at the time of sale, include the leg covers, or leg covers and rail covers.

When installed, the bed covers 10 help protect a person by a bed frame 14 from having a foot, for example, contact the steel bed frame 14. This can be painful. With the bed leg covers 10, if a foot were to contact the bed cover, it would be less painful than the steel bed frame. Further, with the proximity sensor 50 operated light 26 turned on by a person near the bed, when in the dark, the light 26 provides illumination to aid the person's sight when moving around the bed.

Various other features of this disclosure are set forth in the following claims.

1. A decorative leg cover for a bed frame including a rectangular frame, and at least two perpendicularly extending legs, each leg connected to and extending from about a corner of the rectangular frame, the leg cover comprising:
a light including a light housing having a front side and a back side, the light further including an LED on the front side of the light housing, and a proximity sensor on the front side and operable to turn the LED on when it senses movement near the light, and then turn off the light a short time duration thereafter, and
a receptacle for receiving the leg, the receptacle having a receptacle opening therein adapted to receive the leg, the light being mounted in the receptacle so that the LED shines away from the receptacle.

2. The decorative leg cover according to claim 1 and further including an on off switch on the back side of the light housing and operable to turn the LED light on and off.

3. The decorative leg cover according to claim 1 wherein the light housing relatively thin in thickness between the front side and the back side.

4. The decorative leg cover according to claim 1 wherein the receptacle is made of semi-rigid material.

5. The decorative leg cover according to claim 1 and further including a recess in the exterior of the receptacle, the recess receiving the light therein so that the LED shines away from the receptacle.

6. The decorative leg cover according to claim 1 and further including a foam material received in the receptacle opening, the foam material having a leg opening therein adapted to receive the leg.

7. The decorative leg cover according to claim 6 wherein the foam material can flow and conform to a variety of leg width dimensions.

8. A decorative bed frame cover assembly, the bed frame cover assembly including at least two leg covers, each leg cover comprising:
a light including a light housing having a front side and a back side, the light further including an LED on the front side of the light housing, and a proximity sensor on the front side and operable to turn the LED on when it senses movement near the light, and then turn off the light a short time duration thereafter, and
a receptacle for receiving the leg, the receptacle having a receptacle opening therein adapted to receive the leg, and the light being mounted in the receptacle so that the LED shines away from the receptacle, and
a rail cover attached to and extending between two of the leg covers, the two leg covers beings paced apart so that each leg cover can receive a different one of the at least two legs, the rail cover having a height extending parallel to the legs, the rail cover being attached to a side of each of the leg covers, with the LED of each leg cover shining toward the LED of the other cover.

9. The decorative leg cover according to claim 8 wherein the height of the rail cover being sufficient to covers the height of the bed frame side.

10. A decorative leg cover for a bed frame including a rectangular frame, and at least two perpendicularly extending legs, each leg connected to and extending from about a corner of the rectangular frame, the leg cover comprising:
a light including a light housing having a front side and a back side, the light further including an LED on the front side of the light housing, and a proximity sensor on the front side and operable to turn the LED on when it senses movement near the light and then turn off the light a short time duration thereafter,
a receptacle for receiving a leg, the receptacle having a receptacle opening therein adapted to receive a leg, the light being mounted in the receptacle so that the LED shines away from the receptacle,
the light housing being relatively thin in thickness between the front side and the back side, and
a recess in the exterior of the receptacle, the recess receiving the light therein so that the LED shines away from the receptacle.

11. The decorative leg cover according to claim 10 and further including a foam material received in the receptacle opening, the foam material having a leg opening herein adapted to receive the leg.

12. The decorative leg cover according to claim 10 wherein the foam material can flow and conform to a variety of leg dimensions.

13. A decorative bed frame including a rectangular frame, and four perpendicularly extending legs, each leg connected to and extending from about a corner of the rectangular frame, and a leg cover for each leg, each leg cover comprising:
a light including a light housing having a front side and a back side, the light further including an LED on the front side of the light housing, and a proximity sensor on the front side and operable to turn the LED on when it senses movement near the light, and then turn off the light a short time duration thereafter, and
a receptacle for receiving the leg, the receptacle having a receptacle opening therein adapted to receive the leg, the light being mounted in the receptacle so that the LED shines away from the receptacle.

14. The decorative bed frame according to claim 13 and further including a rail cover attached to and extending between each pair of two leg covers, the two leg covers being spaced apart so that each leg cover receives a different one of the at least two legs, the rail cover having a height extending parallel to the legs, the rail cover being attached to a side of each of the leg covers, with the LED of each leg cover shining toward the LED of the other cover.
